(19) United States
(12) Patent Application Publication
(10) Pub. No.: US 2026/0194318 A1
(43) Pub. Date: Jul. 9, 2026

(54) DISTRIBUTION SYSTEM, ARRANGEMENT AND METHOD FOR PRODUCING A DISTRIBUTION SYSTEM

(71) Applicant: TI Automotive Technology Center GmbH, Rastatt (DE)

(72) Inventors: Irfan KIZILAY, Reilingen (DE); Stefan LEIPOLD, Seltz (FR); Manuel LINDOW, Gernsbach (DE)

(21) Appl. No.: 19/444,046

(22) Filed: Jan. 8, 2026

(30) Foreign Application Priority Data
Jan. 9, 2025 (EP) 25150877.6

(51) Int. Cl. F28F 27/02; B29C 49/20; B29C 49/42; B29L 31/18

(52) U.S. Cl. CPC F28F 27/02; B29C 49/20; B29C 49/4268; B29C 2049/2008; B29L 2031/18

(57) ABSTRACT

Distribution system, comprising a housing designed as a blow-molded part with a chamber, wherein at least one fluid channel opens into the chamber, wherein a functional element is movably accommodated in the chamber, wherein an adapter element for accommodating an actuator influencing the functional element is arranged on the housing, wherein the adapter element is fixed to the housing by forming the housing during blow molding.

### RELATED APPLICATIONS

The present disclosure claims priority to and the benefit of European Application 25150877.6, filed on January 9, 2025, the entire contents of each of which are incorporated herein by reference.

### FIELD

The present disclosure relates to a distribution system having a housing designed as a blow-molded part with a chamber, wherein at least one fluid channel opens into the chamber, wherein a functional element is movably accommodated in the chamber, wherein an adapter element for accommodating an actuator influencing the functional element is arranged on the housing, as well as an arrangement and a method for producing a distribution system.

### BACKGROUND

Distribution systems are used in cooling circuits, for example, to control the flow of coolant. A channel structure is incorporated into the distribution system, which controls the coolant flow. Depending on the design and number of fluid openings and the channel structure, different cooling circuits can be supplied, the volume flow can be adjusted, or the flow direction can be controlled.

Coolant flows in distribution systems are often influenced by rotary valves. These offer the advantage that the coolant flow is controlled by rotating the valve core, wherein the actuator for rotating the valve core is simply designed and easy to control. Accordingly, rotary valves and the corresponding actuators can be produced inexpensively. In addition, rotary valves have a small installation space. Furthermore, rotary valves can be integrated directly into the distribution system, wherein the walls of the distribution systems can be components of the rotary valve, for example the housing can be integrally formed with the distribution system.

Distribution systems are used, for example, in temperature control circuits in the field of electromobility. Batteries in electric vehicles, especially lithium-ion batteries, are actively cooled or heated depending on the ambient temperature, as they only achieve optimum performance within a defined temperature range. The drive unit of an electric vehicle therefore generally has a temperature control circuit through which temperature control media are fed to the cells of the battery in order to keep them within a required temperature range. Other components of the drive unit, such as the power electronics, the electric motor, the charging electronics and the corresponding plug connections and cables, can also be temperature-controlled, in particular cooled. A further area of application for distribution systems is stationary energy storage devices.

Depending on requirements, the temperature control medium in the temperature control circuit can either be heated in a heating device or cooled in a cooling device, which is why such temperature control circuits represent a comparatively complex structure. Rotary valves make reliable control of the temperature control medium flow possible and can be integrated into the temperature control circuit in a space-saving manner.

### BRIEF SUMMARY

The present disclosure provides a distribution system that can be produced simply and inexpensively. Further the present disclosure provides a method for producing a distribution system by way of which the distribution system can be produced simply and inexpensively.

The distribution system according to the present disclosure for distributing temperature control media comprises a housing designed as a blow molded part with a chamber, wherein at least one fluid channel opens into the chamber and a functional element is movably accommodated in the chamber, wherein an adapter element for accommodating an actuator influencing the functional element is arranged on the housing, and wherein the adapter element is fixed to the housing by forming the housing during blow molding.

In the distribution system, it is therefore provided that the functional element is arranged inside the housing and the actuator can be attached externally to the housing by means of the adapter element fixed to the housing. The adapter element thus forms an interface via which the actuator influencing the functional element can be connected directly or indirectly to the housing.

The housing designed as a blow-molded part enables the production of housings with a wide variety of shapes, while the adapter element fixed to the housing enables the actuator to be securely accommodated, wherein the connectivity of the adapter element can be adapted to a specifically selected actuator. This is achieved by designing the adapter element in such a way that it can accommodate different types of actuators. Consequently, accommodating different types of actuators only requires a corresponding adaptation of the adapter element to the respective actuator and not of the entire housing, so that said housing can be designed as a standardized component. This flexible adaptability of the valve to different actuators can make it possible for the valve to be produced simply, quickly and inexpensively.

In one embodiment, the adapter element can be formed integrally with the housing by forming the housing during blow molding.

In particular, the housing and the adapter element can be formed as an integral blow-molded part. In other words, the housing and the adapter element can form a one-piece, integral base body. In doing so, the housing and the adapter element can be formed by blow molding just one preform or by blow molding a plurality of preforms. As the housing and the adapter element form an integral blow-molded part, a particularly quick and inexpensive production of the distribution system can be made possible.

An alternative embodiment of the distribution system can provide for the adapter element to be connected to the housing in a positive locking and/or materially bonded manner.

Preferably, the adapter element and the housing form separate components that are connected to each other by the blow molding process in a positive locking and/or materially bonded manner. The adapter element can, for example, be provided as a molded part and, by blow molding the preform to be shaped into the housing, be connected to the same. The positive locking and/or materially bonded connection between the housing and the adapter element means that both parts can be firmly connected to each other in a media-tight manner. No additional sealing elements are therefore required between the housing and the adapter element.

The adapter element can have any geometric design, for example, in a plan view it can form an essentially disc-shaped, in particular circular or oval, base area. The adapter element can also form an angular or free-form base area. Preferably, the adapter element is formed of a polymer material, for example a thermoplastic polymer. The material of the adapter element is selected in particular in such a way that the adapter element is dimensionally stable during blow molding. Advantageously, the melting temperature of the plastic selected for the adapter element is therefore above a temperature required for blow molding the preform to form the base body. Alternatively, the adapter element can also be formed of a metallic material.

A further advantageous embodiment of the valve can provide that the adapter element has a plurality of positive locking elements that are connected to the housing. The positive locking elements can be used to form at least the positive locking connection between the housing and the adapter element. In particular, the housing can come to rest against the positive locking element during the blow molding process, for example by engaging with it or engaging in it. The positive locking elements can take the form of recesses and/or indentations on the adapter element, wherein the housing extends at least partially into these to form the positive locking connection.

The distribution system can be designed as a valve, in particular as a rotary valve. In this design, the functional element forms a valve core, and the housing forms a valve housing. In the design as a rotary valve, the valve core is rotatably mounted in the valve housing. In particular, the valve core can perform a rotational movement within the valve chamber, but is prevented from moving in an axial direction relative to the valve housing. Preferably, the valve core is held in the valve chamber in a loss-proof manner. This allows both a simple and compact integration of the valve core into the valve housing and a simplified design of the valve housing.

According to one embodiment of the valve, the functional element can be provided with a drive shaft which is led out of the housing through an opening provided in the housing. Preferably, the drive shaft is radially mounted and coupled to the valve core so that the drive shaft causes an actuating movement of the valve core within the valve chamber by means of a rotational movement. By the drive shaft extending through the opening in the housing, it can be coupled to the actuator accommodated on the adapter element. This allows the actuator to control the actuating movement of the valve core via the drive shaft.

A further embodiment of the arrangement can provide for the adapter element to have a passage through which the drive shaft that is led out of the housing extends. The drive shaft can extend through the passage directly from the valve core to the actuator fastened to the adapter element. The passage can form the radial mounting of the drive shaft. For example, the passage can be provided with a bearing device for mounting the drive shaft and/or with a sealing element. By means of the passage in the adapter element, a simple and compact design of the valve is thus made possible.

Advantageously, it can be provided for the valve that the adapter element has a central part in which the passage is formed and has a plurality of retaining sections by which the adapter element is fixed to the housing.

The central part can form a structural base body of the adapter element, on which the retaining sections are formed and/or from which the retaining sections extend. The passage can be provided as an opening or hole in the central part.

The central part is not limited to a specific shape, for example it can have a round, oval, angular or any other shape. Preferably, the central part can be designed circular. Due to the circular design of the central part, the passage can be formed in a central region of the central part. The retaining sections can be formed on an outer circumference of the central part and extend away from the central part, for example. The retaining sections can be formed either entirely or in sections on the outer circumference of the central part. Preferably, the retaining sections are formed integrally with the central part.

According to an advantageous embodiment of the valve, the retaining sections can be designed as retaining arms on the central part. The retaining arms can position the central part within the opening provided in the housing.

Preferably, the retaining arms can be designed in such a way that the central part is arranged by them at a radial distance from an edge region of the housing bounding the opening. For this purpose, the central part can be designed to be smaller than the inside diameter of the opening in the housing.

Advantageously, at least two retaining arms, for example three, four, five or more retaining arms, can be formed on the central part. The retaining arms can extend away from the central part of the adapter element in a star shape. Preferably, the retaining arms are connected to the housing at their respective end sections in a positive locking and/or materially bonded manner. For this purpose, the positive locking elements can be formed on the retaining arms, in particular on the respective end sections of the retaining arms.

A further development of the valve can also provide that the adapter element has a positive locking geometry that is detachably coupled to a corresponding positive locking geometry on a coupling element for fastening the actuator or on the actuator. In this way, the adapter element is locked in place with the coupling element or the actuator via a positive locking connection. Such a positive locking connection is easy to produce and can be reversibly released to separate the coupling element or the actuator from the adapter element. Advantageously, the corresponding positive locking geometries can form a bayonet lock.

The coupling element for fastening the actuator can be provided with connecting means for fastening the actuator. The connecting means can, for example, form a screw connection, snap-in connection, clip connection or the like in order to fasten the actuator preferably detachably to the coupling element. The coupling element can also have a further positive locking geometry, which allows a positive locking connection to be formed between the coupling element and the actuator. The positive locking geometry can be designed in such a way that the actuator is firmly connected to the distribution system without additional fastening elements such as screws or riveted joints. This reduces installation costs and installation time.

The arrangement according to the present disclosure comprises at least one actuator and at least one distribution system according to one of the embodiments described above, wherein the actuator is accommodated by the adapter element of the distribution system. As an alternative to the actuator, the arrangement can comprise a further functional element that interacts with the distribution system instead of the actuator. In this context, it is conceivable, for example, that the functional element is designed as a sensor or orientation sensor. It is further conceivable that the arrangement comprises a combination of an actuator and a further functional element, which preferably form a structural unit and are accommodated by the adapter element.

Such an arrangement is used in particular in a temperature control device, for example a temperature control device in an electric vehicle. To control the distribution system, the actuator is designed to control an element of the distribution system. The actuator preferably forms an actuating drive, for example in the form of an electric motor, to control an actuating movement of the element.

In a further development of the valve arrangement, it can be provided that the actuator is coupled to the drive shaft of the distribution system and is configured to rotate the functional element.

In particular, the actuator and the functional element of the distribution system are coupled to each other by the drive shaft in such a way that a rotary actuating movement of the functional element can be controlled by the actuator via the drive shaft.

In the method according to the present disclosure for producing a distribution system, in particular a valve according to one of the embodiments described above, a preform consisting of polymeric material and a valve core are provided and arranged in a blow mold, wherein a housing is formed from the preform, in which the valve core is accommodated, wherein the preform connects to an adapter element while being molded into the housing.

According to a first embodiment, an adapter element can be arranged in the blow mold before blow molding, wherein the preform comes to rest against the adapter element arranged in the blow mold during blow molding.

According to a second embodiment of the method, the preform is formed in such a way that the adapter element for accommodating the actuator influencing the functional element is formed integrally with the housing.

Preferably, this method allows both the housing with the functional element accommodated therein to be formed as well as the adapter element to be fixed to the housing in just one blow molding process step.

According to the first embodiment of the method, the adapter element can be connected to the housing as a separate component in a positive locking and/or materially bonded manner by blow molding or, according to the second embodiment, it can be formed integrally with the housing by forming the housing during the blow molding process. In this way, a simple, quick and thus cost-optimized production of the distribution system can be achieved.

In addition, the method offers the possibility of a flexible design of the adapter element so that different types of actuators can be accommodated by the adapter element.

The preform for producing the housing can preferably have a tubular initial shape, in particular with only one continuous interior space. By blow molding from such a preform, the housing can be formed with the chamber provided therein and the functional element arranged therein as well as the at least one fluid channel opening into the chamber. Preferably, at least one inlet channel and at least one outlet channel are formed by blow molding, which open into the chamber and are connected via the chamber in a flow-conducting manner.

The melting temperatures of the material of the preform and the material of the adapter element can be selected in such a way that the preform can be softened for blow molding the housing, wherein the adapter element arranged in the blow mold remains dimensionally stable during the blow molding operation.

### BRIEF DESCRIPTION OF THE DRAWINGS

Some embodiments of the distribution system according to the present disclosure and of the arrangement according to the present disclosure will be explained in more detail below with reference to the figures. These show, each schematically:

FIG. 1 a perspective view of a housing after blow molding;

FIG. 2 a perspective view of a housing with an attached coupling element;

FIG. 3 a perspective view of an arrangement;

FIG. 4 a sectional view of an arrangement with a distribution system according to FIG. 1 to FIG. 3.

### DETAILED DESCRIPTION

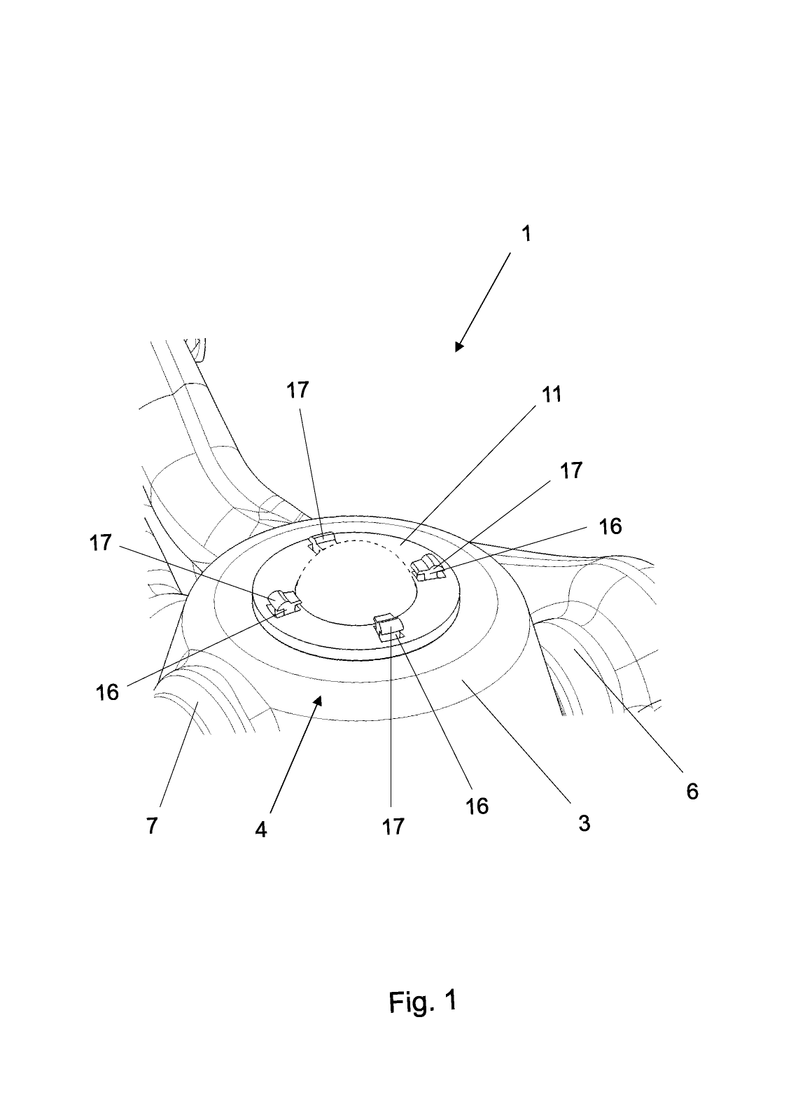

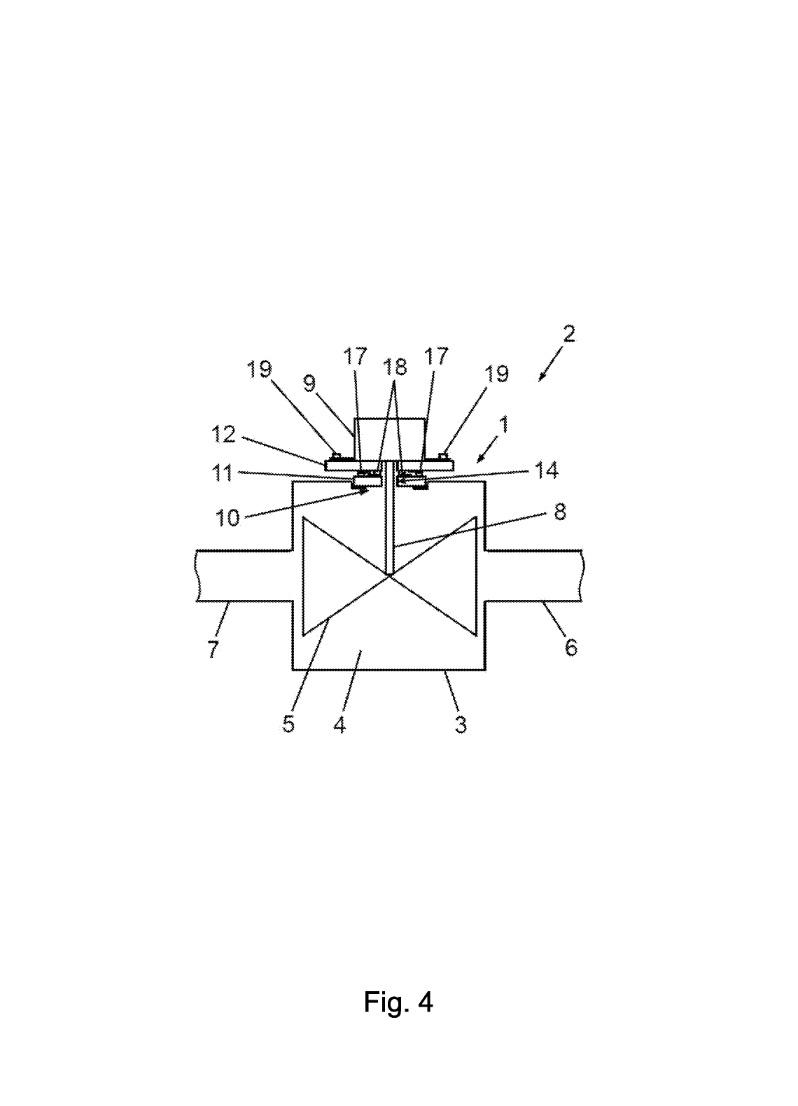

FIG. 1 shows a housing 3 of a distribution system 1 designed as a blow-molded part. A chamber 4 is formed inside the housing 3, in which a functional element 5 (FIG. 4) is arranged. A first fluid channel 6, for example an inlet channel, and a second fluid channel 7, for example an outlet channel, open into the chamber 4. Alternatively, it can also be provided for more than two fluid channels 6, 7 to open into the chamber 4. For example, three, four, five, six or more fluid channels of a temperature control circuit can also open into the chamber 4 of the distribution system 1.

In the embodiments shown in the figures, the distribution system 1 is designed as a rotary valve. The functional element 5 forms a valve core, the chamber 4 a valve chamber and the housing 3 a valve housing. The valve core is rotatably accommodated in the valve housing.

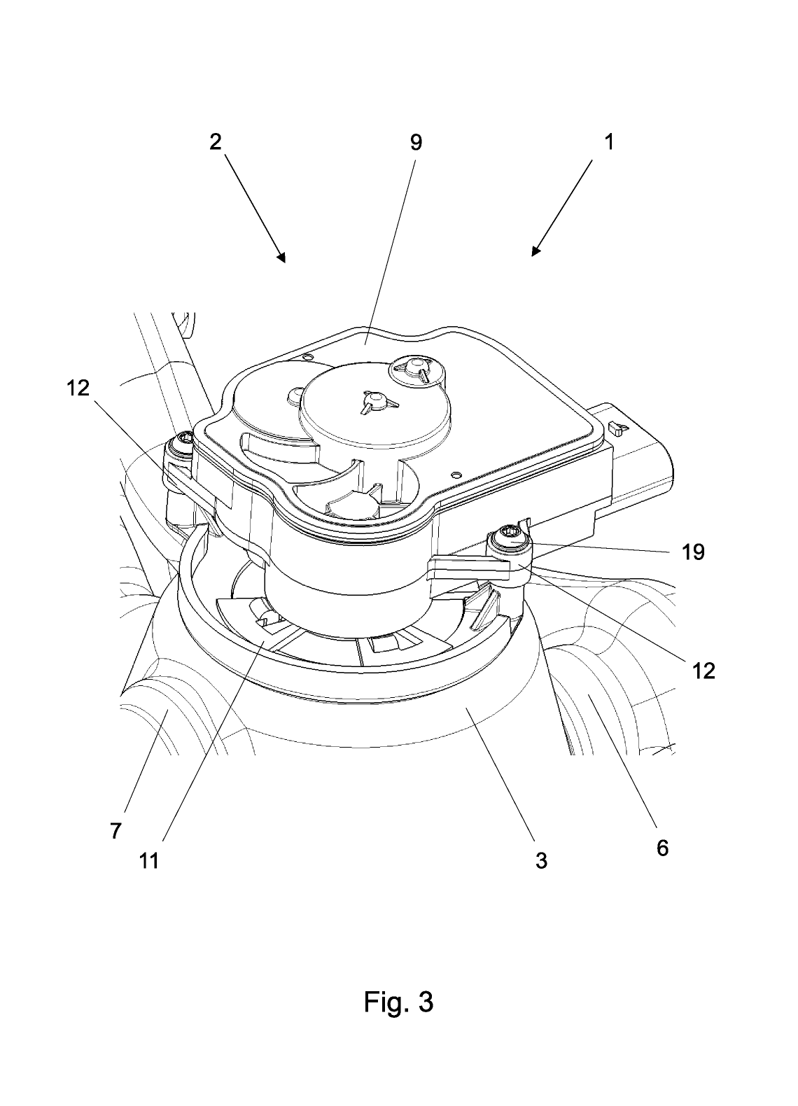

For fastening an actuator 9, an adapter element 11 is provided on the housing 3, which is detachably coupled to a coupling element 12 provided on the actuator 9 for accommodating the actuator 9 (FIG. 3).

The adapter element 11 is fixed to the housing 3 by forming the housing 3 during the blow molding process. The adapter element 11 is provided for the blow molding process, in particular as a separate component, and, by forming the preform into the housing 3, it is connected to the housing in a positive locking and/or materially bonded manner.

For this purpose, the housing 3 and the adapter element 11 are formed of a plastic material, for example polypropylene, polyamide or polyethylene. The housing 3 and the adapter element 11 can also be formed of other materials.

Preferably, the housing 3 is formed of a plastic whose melting temperature is suitable for the blow molding process and is below the melting temperature of the plastic selected for the adapter element 11.

The adapter element 11 can, for example, be made of an injection-moldable plastic whose melting temperature is selected such that it is above the temperature required for the blow molding process to produce the housing 3.

The adapter element 11 is fixed to the housing 3 in a positive locking and/or materially bonded manner, wherein the positive locking and/or materially bonded connection between the housing 3 and the adapter element 11 is formed by forming the preform into the housing 3 during blow molding. For this purpose, the preform is placed together with the adapter element 11 in a blow molding tool, wherein the preform comes to rest against the adapter element 11 during blow molding and the positive locking and/or materially bonded connection is formed.

Through the blow molding process, the preform is formed in such a way that the housing 3 with the chamber 4 formed therein and the first and second fluid channels 6, 7 opening into the chamber 4 are formed.

In an alternative embodiment of the distribution system 1, the housing 3 and the adapter element 11 can also be formed as an integrally formed component. In particular, the adapter element 11 can be integrally formed together with the housing 3 by forming the housing 3 during the blow molding process. The housing 3 and the adapter element 11 thus form a coherent integral blow-molded part.

A plurality of positive locking elements can be formed on the adapter element 11, through which the positive locking connection between the housing 3 and the adapter element 11 is formed by blow molding. The positive locking elements are formed, for example, as recesses and/or protrusions on the adapter element 11. When the housing 3 is formed during the blow molding process, it comes to rest against the positive locking elements, for example it engages with them or engages in them, thereby forming the positive locking connection.

The adapter element 11 can have any geometric design, for example it can have an essentially ring-shaped, disk-shaped or plate-shaped basic shape.

FIG. 1 shows the housing 3 with the adapter element 11 attached to it after blow molding. The opening 10 provided centrally in the adapter element 11 is still closed and is opened in a subsequent process step.

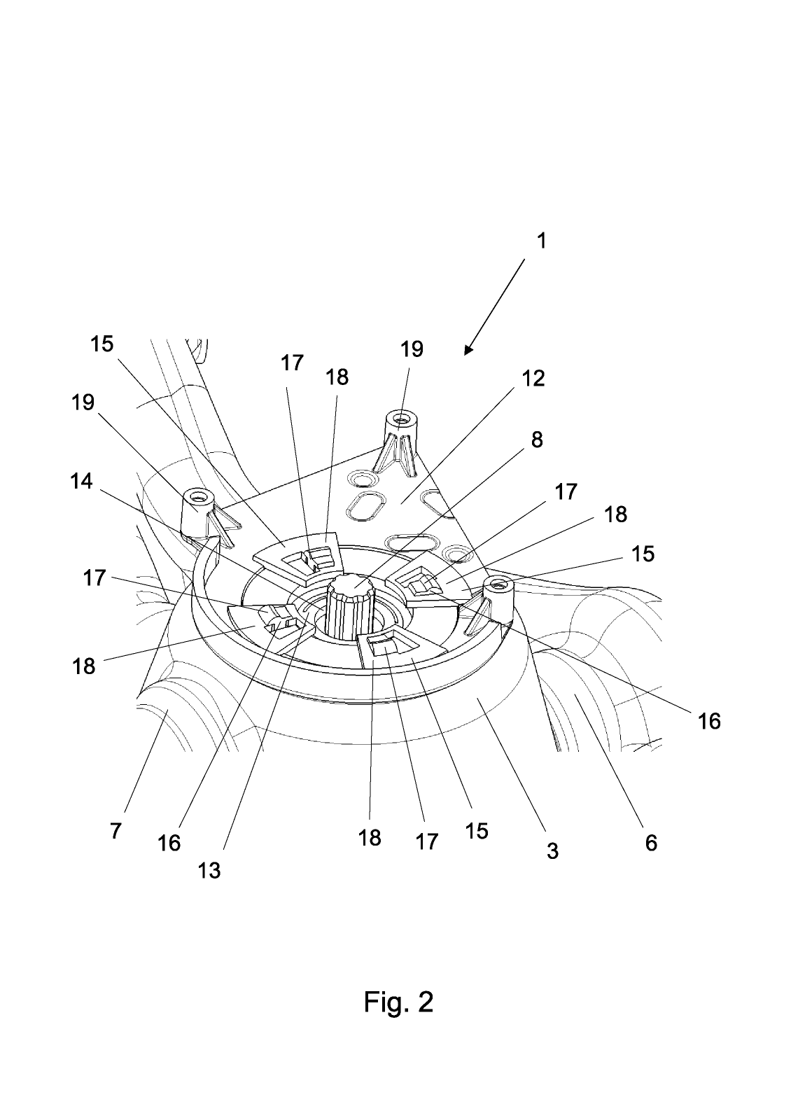

In principle, it is conceivable to fasten a functional element, for example an actuator or a sensor, directly to the adapter element 11. This is particularly conceivable if only low forces or torques act on the adapter element 11 or on the positive locking elements of the adapter element 11. In this simple design, the coupling element 12 shown in FIG. 2 to 4 is omitted.

FIG. 2 shows the housing 3 of the distribution system 1 with the adapter element 11 fitted and positively fastened. The opening 10 centrally associated with the adapter element 11 is created and the drive shaft 8 of the functional element 5 is accessible.

FIG. 3 shows the distribution system 1 according to FIG. 2 with actuator 9 attached. The distribution system 1 shown in FIG. 3 forms one component of an arrangement 2 shown in FIG. 4. Such an arrangement 2 is used, for example, in a temperature control circuit of an electric vehicle not shown in detail. A volume flow of a temperature control medium flowing in the temperature control circuit, e.g., coolant in the form of cooling water, or other media, can be controlled and/or distributed by the arrangement 2 and directed to the components of the electric vehicle to be temperature controlled or other components, for example to the batteries, the electric motors, the power electronics or the heat exchangers for passenger compartment temperature control.

The distribution system 1 comprises a housing 3 designed as a blow-molded part. A chamber 4 is formed inside the housing 3, in which a functional element 5 (FIG. 4) is arranged. A first fluid channel 6, for example an inlet channel, and a second fluid channel 7, for example an outlet channel, open into the chamber 4. Alternatively, it can also be provided for more than two fluid channels 6, 7 to open into the chamber 4. For example, three, four, five, six or more fluid channels of a temperature control circuit can also open into the chamber 4 of the distribution system 1.

The functional element 5, here the valve core, is rotatably mounted in the chamber 4. The distribution system 1 is thus designed as a rotary valve. In such a rotary valve, the fluid channels 6, 7 can, for example, be selectively opened or closed, fluidically connected or decoupled from one another by a rotary movement of the functional element 5 in the chamber 4 and/or a volume flow of the medium flowing in the fluid channels 6, 7 can be controlled depending on a corresponding valve position.

To control such a rotary movement, the functional element 5 is coupled to an actuator 9 shown in FIG. 3 via a drive shaft 8. For this purpose, the drive shaft 8 is guided out through an opening 10 provided in the housing 3 and connected to the actuator 9 arranged on the outside of the housing 3. The actuator 9 forms an actuating drive, for example in the form of an electric motor, and causes the rotary movement of the functional element 5 inside the chamber 4 via the drive shaft 8.

According to the embodiment depicted in FIG. 1 and 2 , the adapter element 11 has a central part 13 that forms a circular ring shape. A central passage 14 is formed by the circular ring-shaped central part 13, through which the drive shaft 8 is guided out of the chamber 4.

Four retaining sections 15 are formed on an outer circumference of the central part 13, by means of which the adapter element 11 is fixed to the housing 3. It is understood that the adapter element 11 can also have fewer than four or more than four retaining sections 15. The adapter element 11 is formed as an integral component by the central part 13 and the retaining sections 15.

The retaining sections 15 each form retaining arms 16, which extend in a radial direction away from the central part 13. The retaining arms 16 are attached to an edge region of the housing 3 bounding the opening 10, in particular by the previously described positive locking and/or materially bonded connection by the blow molding process. For this purpose, the positive locking elements for forming the positive locking and/or materially bonded connection between the housing 3 and the adapter element 11 are preferably formed on the retaining arms 16. Due to the retaining arms 16, the central part 13 of the adapter element 11 is arranged in a central region of the opening 10 provided in the housing 3.

A positive locking geometry 17 is formed on the retaining sections 15 of the adapter element 11. This positive locking geometry 17 is formed corresponding to a further positive locking geometry 18 on the coupling element 12, so that the coupling element 12 can be detachably coupled to the adapter element 11. The positive locking geometry 17 on the adapter element 11 and the positive locking geometry 18 on the coupling element 12 together form a bayonet lock for coupling the adapter element 11 to the coupling element 12.

The coupling element 12 forms a plate-shaped component, which can have any geometric design. An opening is provided in the coupling element 12, through which the drive shaft 8 that is guided out of the housing 3 extends.

A plurality of connecting means 19 are provided on the coupling element 12, by means of which the actuator 9 is attached to the coupling element 12. The connecting means 19 are preferably formed by screw elements. Alternatively, the connecting means 19 can also be designed as a snap-in connection, clip connection, riveted connection, welded connection, adhesive connection or the like for fastening the actuator 9 to the coupling element 12. Alternatively, the coupling element 12 can also form a component of a housing of the actuator 9.

1. A distribution system, comprising a housing designed as a blow-molded part with a chamber, wherein at least one fluid channel opens into the chamber, wherein a functional element is movably accommodated in the chamber, wherein an adapter element for accommodating an actuator influencing the functional element is arranged on the housing, and wherein the adapter element is fixed to the housing by forming the housing during blow molding.

2. The distribution system according to claim 1, wherein the adapter element is formed integrally with the housing by forming the housing during blow molding.

3. The distribution system according to claim 1, wherein the adapter element is connected to the housing in a positive locking and/or materially bonded manner.

4. The distribution system according to claim 1, wherein the adapter element has a plurality of positive locking elements which are connected to the housing.

5. The distribution system according to claim 1, wherein the distribution system forms a rotary valve, the functional element forms a valve core and the housing forms a valve housing, wherein the valve core is rotatably mounted in the housing.

6. The distribution system according to claim 5, wherein the functional element is provided with a drive shaft which is led out of the housing through an opening provided in the housing.

7. The distribution system according to claim 6, wherein the adapter element has a passage through which the drive shaft that is led out of the housing extends.

8. The distribution system according to claim 7, wherein the adapter element has a central part in which the passage is formed, and has a plurality of retaining sections by means of which the adapter element is fixed to the housing.

9. The distribution system according to claim 8, wherein the retaining sections are designed as retaining arms on the central part, wherein the retaining arms position the central part within the opening provided in the housing.

10. The distribution system according to claim 1, wherein the adapter element has a positive locking geometry which is detachably coupled to a corresponding positive locking geometry on a coupling element for fastening the actuator or on the actuator.

11. An arrangement, comprising at least one actuator and at least one distribution system according to claim 1, wherein the actuator is accommodated by the adapter element of the distribution system.

12. The arrangement according to claim 11, wherein the actuator is coupled to the drive shaft of the distribution system and is configured to rotate the functional element.

13. A method for producing the distribution system according to claim 1, in which a preform consisting of polymeric material, and the functional element are provided and arranged in a blow mold, wherein the housing is formed from the preform, in which the functional element is accommodated, and wherein the preform connects to the adapter element while being molded into the housing.

14. The method according to claim 13, wherein the adapter element is arranged in the blow mold before blow molding and the preform comes to rest against the adapter element arranged in the blow mold during blow molding.

15. The method according to claim 13, wherein the preform is formed in such a way that the adapter element for accommodating the actuator influencing the functional element is formed integrally with the housing.
